(19) United States
(12) Patent Application Publication
(10) Pub. No.: US 2013/0308849 A1
(43) Pub. Date: Nov. 21, 2013

(54) SYSTEMS, METHODS AND COMPUTER READABLE STORAGE MEDIUMS STORING INSTRUCTIONS FOR 3D REGISTRATION OF MEDICAL IMAGES

(71) Applicants: Baowei Fei, Atlanta, GA (US); Hamed Akbari, Philadelphia, PA (US)

(72) Inventors: Baowei Fei, Atlanta, GA (US); Hamed Akbari, Philadelphia, PA (US)

(73) Assignee: EMORY UNIVERSITY, Atlanta, GA (US)

(21) Appl. No.: 13/981,830

(22) PCT Filed: Feb. 13, 2012
(86) PCT No.: PCT/US12/24884

§ 371 Date: Jul. 25, 2013

Related U.S. Application Data
(60) Provisional application No. 61/441,815, filed on Feb. 11, 2011.

(51) Int. Cl. G06T 7/00

(52) U.S. Cl. CPC G06T 7/0012
USPC 382/131

(57) ABSTRACT

Systems, methods and computer-readable storage mediums relate to processing to segment ultrasound images of an object. The processing may be based on three different planes. The processing may include applying a wavelet transform to image data in each plane to extract the texture features; and applying a trained support vector machine to classify the texture features.

### CROSS REFERENCE TO RELATED APPLICATION

This application claims priority to U.S. Provisional Application Ser. No. 61/441,815 filed Feb. 11, 2011, which is hereby incorporated by this reference in its entirety.

### ACKNOWLEDGEMENTS

This invention was made with government support under Grants RO1CA156775, NIH P50CA128301, NIH P50CA128613, and ULI RR025008 awarded by the National Institutes of Health. The government has certain rights in the invention.

### BACKGROUND

Ultrasound imaging provides portable, cost-effective, real-time imaging without exposure to radiation. It has been widely used for image-guided diagnosis and therapy.

For example, ultrasound imaging has been widely used for the management of prostate diseases. Prostate cancer is the second leading cause of cancer mortality in American men. It is estimated that there are 240,890 new cases and 33,720 deaths of prostate cancer the United States in 2011. See, e.g., Siegel et al., CA Cancer J. Clin., 2011, 61(4):212-36. Transrectal ultrasound (TRUS)-guided biopsy has been the gold standard for definitive diagnosis of the prostate. Currently, two-dimensional (2D) ultrasound images are used to guide a biopsy needle to take tissue sample for pathological examination. However, the current procedure is limited by 2D image guidance and does not have the capability for accurate, targeted biopsy of suspicious lesions in the prostate. Three-dimensional (3D) ultrasound image-guided biopsy systems have been under evaluation for prostate diagnosis. Precise prostate segmentation in 3D ultrasound images has a key role in not only accurate placement of a biopsy needle but also many prostate-related applications. For example, the segmentation of the prostate will help physicians to plan brachytherapy for radiation seed implantation and to measure the volume of the prostate gland.

However, ultrasound image segmentation for boundary delineation of the target object is a difficult task because of the uncertainty of the segmentation boundary caused by speckle noise and because of a relatively low signal-to-noise ratio and a low contrast between areas of interest on the image. See, e.g., Noble JA and Boukerroui D., IEEE TransMedlmaging 2006, 2006, 25(8):987-1010. Also, ultrasound segmentation is influenced by the quality of the data. Attenuation, shadows, and signal dropout due to the orientation dependence of image acquisition can result in missing boundaries and thus can cause problems in ultrasound segmentation. For example, with respect to segmentation of a prostate in ultrasound images, the shadows from the bladder, the relatively small size of the gland, and a low contrast between the prostate and non-prostate tissue can make it difficult to segment the prostate.

Many methods were proposed to automatically segment the prostate in ultrasound images. Various shape model based methods have been used to guide the segmentation. Gong et al. modeled the prostate shape using superellipses with simple parametric deformations. See Gong et al., IEEE Transactions on Medical Imaging, 2004, 23(3):340-9. Ding et al. described a slice-based 3D prostate segmentation method based on a continuity constraint, implemented as an autoregressive model. See, Ding et al., Medical Physics, 2007, 34(11):4109-25. Hu et al. used a model-based initialization and mesh refinement for prostate segmentation. See Hu et al., MedPhys., 2003, 30(7):1648-59. Hodge et al. described 2D active shape models for semi-automatic segmentation of the prostate and extended the algorithm to 3D segmentation using rotational-based slicing. See Hodge et al., ComputMethods Programs Biomed., 2006, 84(2-3):99-113. Tutar et al. proposed an optimization framework where the segmentation process is to fit the best surface to the underlying images under shape constraints. See Tutar et al., IEEE Transactions on Medical Imaging, 2006, 25(12):1645-54. Zhan et al. proposed a deformable model for automatic segmentation of the prostates from 3D ultrasound images using statistical matching of both shape and texture and Gabor support vector machines. See Zhan et al., IEEE Transactions on Medical Imaging, 2006, 25(3):256-72. Ghanei et al. proposed a 3D deformable surface model for automatic segmentation of the prostate. See Ghanei et al., MedPhys., 2001, 28(10):2147-53. Pathak et al. used anisotropic diffusion filter and prior knowledge of the prostate for the segmentation. See Pathak et al., IEEE Transactions on Medical Imaging, 2000, 19(12):1211-9.

Others proposed wavelet-based methods for the segmentation of the prostate. Knoll et al. used snakes with shape restrictions based on the wavelet transform for outlining the prostate. See Knoll et al., Pattern Recognition, 1999, 32(10):1767-81. Chiu et al. introduced a semi-automatic segmentation algorithm based on the dyadic wavelet transform and the discrete dynamic contour. See Chiu et al., Physics in Medicine and Biology, 2004, 49(21):4943-60. Zhang et al. disclosed a prostate boundary detection system that employs tree-structured nonlinear filter, directional wavelet transforms and tree-structured wavelet transform. See Zhang et al., ComputBiolMed, 2007, 37(11):1591-9.

Although advanced segmentation methods have been proposed, for example, for prostate ultrasound images, manual segmentation has been the gold standard and is used in many clinical applications because of reliability. However, manual segmentation is time consuming, highly subjective, and often irreproducible.

Thus, there is a need for an imaging processing technique that accurately and automatically segments ultrasound images of a target object.

### SUMMARY

The disclosure relates to methods, systems, computer-readable mediums storing instructions for segmenting images of a target object. The segmentation may be automated.

In some embodiments, the disclosure may relate to a method for processing at least one image of a target object, the image including image data in at least three different planes. In some embodiments, the method may include processing the image data in each plane to segment the target object represented by the image, the processing including classifying the image data based on a reference probability shape model and an intensity profile; and generating at least one segmented image. In some embodiments, the planes may include sagittal plane, coronal plane, and transverse plane. In some embodiments, the reference probability shape model may be based on a plurality of manually segmented images of the object. In some embodiments, the intensity profile may be based on the image of the target object.

In some embodiments, the processing may include separately classifying the image data in each plane. In some embodiments, the target object may be a prostate, breast, lung, lymph node, kidney, cervix, and liver. In some embodiments, the processing the image data may include processing regions of the image.

In some embodiments, the processing may include extracting texture features in each plane; and classifying the texture features in each plane as object data or non-object data. In some embodiments, the extracting may include applying a wavelet transform to image data in each plane. In some embodiments, the classifying may include applying a trained support vector machine. In some embodiments, the support vector machine may be a kernel-based support vector machine. In some embodiments, the method may include registering the generated segmented image to the probability model.

In some embodiments, the method may include modifying at least one boundary between the object data and the non-object data of the generated segmented image based on the intensity profile; and generating an updated segmented image based on the modified boundary.

In some embodiments, the method may include outputting the generated segmented image. In some embodiments, the method may further include outputting the generated segmented image. In some embodiments, the image may be an ultrasound image.

In some embodiments, the method may include determining the intensity profile from the image. The method may include determining a boundary from the intensity profile. In some embodiments, the method may include modifying the boundary of the registered segmented image based on a comparison of the boundary from the intensity profile to the boundary from the registered segmented image. In some embodiments, the method may further include updating the segmented boundary based on the modified boundary. In some embodiments, the modifying and updating may be repeated until a predetermined parameter is met. The predetermined parameter may include at least one of similarities between the boundaries and a predetermined number of updates.

In some embodiments, the disclosure may relate to a computer-readable storage medium storing instructions for processing at least one image of a target object, the image including image data in at least three different planes. The instructions may include: processing the image data in each plane to segment the target object represented by the image, the processing including classifying the image data based on a reference probability shape model and an intensity profile; and generating at least one segmented image.

In some embodiments, the processing may include extracting texture features in each plane; and classifying the texture features in each plane as object data or non-object data. In some embodiments, the extracting may include applying a wavelet transform to image data in each plane. In some embodiments, the classifying may include applying a trained support vector machine.

In some embodiments, the medium may include further instructions for registering the generated segmented image to the probability model. In some embodiments, the medium may include instructions for comparing the boundary between the object data and the non-object data of the generated image to a corresponding boundary of the intensity profile. In some embodiments, the medium may include instructions for modifying at least one boundary between the object data and the non-object data of the generated segmented image based on the comparing. The medium may further include instructions for generating an updated segmented image based on the modified boundary.

In some embodiments, the disclosure may relate to a system configured to process at least one image of a target object, the image including image data in at least three different planes. The system may include an image processor. The image processor may be configured to process the image data in each plane to segment the target object represented by the image, the process including classify the image data based on a reference probability shape model and an intensity profile; and generate at least one segmented image.

In some embodiments, the image processor may be configured to process the image data by extracting texture features in each plane and classifying the texture features in each plane as object data or non-object data. In some embodiments, the processor may be configured to apply a wavelet transform to image data in each plane to extract the texture features; and is configured to apply a trained support vector machine to classify the texture features.

### BRIEF DESCRIPTION OF THE DRAWINGS

The disclosure can be better understood with the reference to the following drawings and description. The components in the figures are not necessarily to scale, emphasis being placed upon illustrating the principles of the disclosure.

FIG. 1 shows a method according to embodiments for processing images of an object to segment the object;

FIG. 2 illustrates an example of feature extraction of a prostate using various filters;

FIG. 3 shows a method according to embodiments for training support vector machines (SVMS) in three orthogonal planes and generating a probability shape model of a target object;

FIG. 4 shows an example of a probability shape model of a prostate;

FIG. 5 shows an example of ultrasound image and intensity profile of a prostate;

FIG. 6 shows an example of intensity profiles of the prostate with different cube widths;

FIG. 7 shows an example of prostate ultrasound images and corresponding intensity profiles;

FIG. 8 shows an example of a segmentation result of a prostate using the method according to embodiments; and

FIG. 9 shows an example of a system configured to segment images according to embodiments.

### DETAILED DESCRIPTION OF THE EMBODIMENTS

The following description, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

The methods are described with respect to transrectal-ultrasound (TRUS) guided prostate biopsy, prostate, ultrasound (US) images, and TRUS images. However, it should be understood that the disclosure is not limited to prostate, TRUS, and TRUS images. The disclosure may be applied to ultrasound guided biopsies and/or ultrasound images of other anatomical regions, including, but not limited, to breast(s), lung(s), lymph node(s), kidney, cervix, and liver.

The disclosure relates to employing texture features and statistical shape models for a target object, e.g., prostate, segmentation. However, the extraction of texture features within and around an object, for example, a prostate, can be difficult. Many conventional image processing techniques generally do not perform well on US, such as TRUS, images. The large variation in feature size and shape can reduce the effectiveness of classical fixed neighborhood techniques. Textures at the object (e.g., prostate) and non-object (e.g., prostate) regions can be similar in many cases. In other words, the distributions of texture features at the object (e.g., prostate) and non-object (e.g., prostate) regions may overlap with each other. Therefore, it can be hard to linearly classify textures in US, such as TRUS, images. Moreover, it can hard to define a global characterization of object (e.g., prostate) textures because the same tissue may have variable texture in different regions of the object (e.g., prostate).

Segmentation according to the methods, computer-readable storage mediums, and systems of the disclosure may address such deficiencies. Several features may contribute to the accuracy and robustness of the algorithm. First, the segmentation according to embodiments may employ wavelet transform for texture extraction the texture features in US images. Texture analysis may be mainly used to segment the image into some homogeneous sub-regions. Texture properties may then be characterized by the spatial distribution of gray levels in a neighborhood and utilized to determine regional homogeneity. Texture extraction using wavelet transform may provide a precise and unifying frame work for the analysis and characterization of a signal at different scales. See, e.g., Zhang et al., Advances in Intelligent Computing, Pt 1, Proceedings, 2005, 3644:165-73. In some embodiments, the selection of the appropriate wavelet transforms may be based on the best results for object (e.g., prostate) classification. Different types of wavelet transform may be applied and classified using SVM. The best results may be chosen for texture extraction. In some embodiments, segmentation may include a set of trained SVMs to adaptively collect texture priors of the prostates and to differentiate tissues in different zones around the prostate boundary by statistically analyzing their textures.

Second, the segmentation according to embodiments may employ kernel-based support vector machine. The inputs of each kernel-based SVM may include wavelet transformations components. Because the object textures may be different in different regions of the object, the W-SVMs may be locally trained and employed in order to characterize texture features in ultrasound images. Because the Wavelet filter bank has different wavelets transform, it may be able to characterize textures with different dominant sizes and orientations from noisy ultrasound images.

Third, the segmentation according to embodiments may employ intensity profiles and probability shape models. An object, such as a prostate, generally may have geometry and location information with a series of constraints. According to these embodiments, these constraints may be incorporated in the probability model. The model may prevent significant variations from the probability shape model. The model may modify the segmentation based on object, e.g., prostate, anatomical knowledge. The intensity profiles may also be used to improve the segmentation based on boundary detection.

### Segmentation Methods

The methods of the disclosure are not limited to the steps described herein. The steps may be individually modified or omitted, as well as additional steps may be added. In some embodiments, all of the steps of the method may be performed automatically. In other embodiments, some steps of the method may be performed manually.

The methods of the disclosure are not limited to the order of steps shown in the figures. The steps may occur simultaneously, sequentially, or a combination thereof.

Unless stated otherwise as apparent from the following discussion, it will be appreciated that terms such as “employing,” “defining,” “acquiring,” “labeling,” “overlying,” “comparing,” “identifying,” “extracting,” “analyzing,” decomposing,” “receiving,” “classifying,” “preprocessing,” “correcting, “slicing,” “separating,” “displaying,” “storing,” “printing,” “quantifying,” “filtering,” “combining,” “reconstructing,” “segmenting,” “generating,” “registering,” “determining,” “obtaining,” “processing,” “computing,” “selecting,” “estimating,” “detecting,” “tracking,” “applying,” “outputting, “defining,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods may be compiled for execution on a variety of hardware platforms and for interface to a variety of operating systems. In addition, embodiments are not described with reference to any particular programming language. It will be appreciated that a variety of programming languages may be used to implement embodiments of the disclosure.

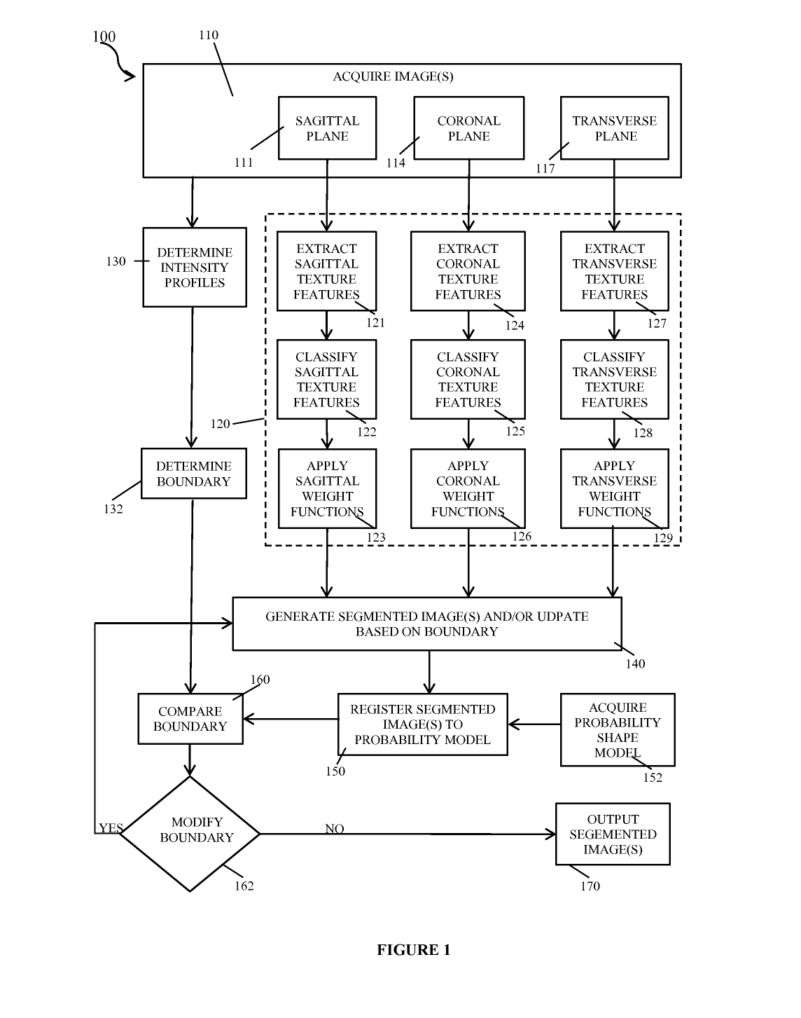

FIG. 1 illustrates a method 100 according to embodiments to process ultrasound image(s) to generate a segmented image(s) of a prostate.

In some embodiments, the method may include a step 110 of acquiring at least one ultrasound image of an object. The image(s) may be preprocessed images. The images may include image data. The image date may be volumetric image data.

The image data may include object (also referred to as object tissue) data and non-object data that is in proximity to the object. In some embodiments, the object data may define an object that is surrounded by non-object data. The object may include but is not limited to an organ included in an anatomical region. In some embodiments, the object may include but is not limited to prostate, breast, lung, lymph node, kidney, cervix, and liver.

In other embodiments, the image may be a 3D ultrasound image. The 3D image may be a transrectal image of a prostate. In some embodiments, the image may be of a different object in the transrectal region or may be a different object in another anatomical region. In other embodiments, the anatomical region may be another anatomical region that may include but is not limited to breast(s), lung(s), lymph node(s), kidney, cervix, and liver.

In some embodiments, the acquired image(s) may include images in different planes. The images may include sagittal, coronal, and transverse images. In some embodiments, the acquiring step may include slicing the image to generate images in different planes.

As shown in FIG. 1, the method 100 may include a step of acquiring image(s) of an object. The images or image data of the object in a sagittal plane 111, a coronal plane 114, and a transverse plane 117.

In some embodiments, the images may be processed for segmentation automatically after acquiring the image data. In some embodiments, before or after the images are acquired but before the images are automatically processed for segmentation, the method may include a manual intervention. In some embodiments, the method may include a manual identification of the object (e.g., location of the prostate) before the automatic segmentation. The manual identification may include manual selection or definition of more than one bounding box for the object (e.g., prostate). In some embodiments, two bounding boxes may be selected. For example, the box may be in one middle slice or two orthogonal slices. The size of the box may be used to scale the probability reference model discussed below.

In some embodiments, the method may include processing the image(s) to segment the object represented by the image. In some embodiments, the processing may include a step of classifying tissues represented by a region of the image data to generate a (initial or first) segmented image. The processing may classify a plurality of sub-regions around a boundary as object tissue and non-object tissue. The classifying may include labeling or identifying voxels as object issue or non-object tissue. For example, with respect to the prostate, the classifying may include labeling or identifying tissues in different sub-regions of the image data as prostate and non-prostate tissue around a prostate boundary.

In some embodiments, the processing may have the ability to characterize textures with different dominant sizes and orientations from noisy US images.

### Wavelet-Based Texture Extraction

In some embodiments, the processing may include a step of extracting the texture or wavelet features of the image in each plane. The extracting may include employing or applying wavelet transforms to the images in each planes.

As shown in FIG. 1, the processing may include steps 121, 124, and 127 of extracting texture features for each of the planes, sagittal, coronal, and transverse, respectively.

Wavelet-based processing algorithms are generally superior due to the ability of wavelets to discriminate different frequencies and to preserve signal details at different resolutions. The capability of the Wavelet filters to zoom in and out can translate signals to a location of a signal that is of interest and dilate themselves properly to preserve the resolution of that portion of the signal. See, e.g., Wang T C and Karayiannis NB, IEEE Transactions on Medical Imaging, 1998, 17(4):498-509. The wavelet transform can decompose a signal to the family functions that generated from a mother wavelet ψ(x) by dilation and translation. See, e.g., Mallat S G., IEE Transactions on Pattern Analysis and Machine Intelligence, 1989, 11(7):674-93.

$${ψ}_{m , n} ( x ) = {{2}^{-}}^{( \frac{m}{2} )} ψ ( {2}^{- m} x - n ) \qquad ( 1 )$$

The mother wavelet may be constructed from the scaling function φ(x) as:

φ(t)=\sqrt{2}Σ_{n=-∞}^{+∞}h[n]φ(2t−n) (2)

ψ(t)=\sqrt{2}Σ_{n=-∞}^{+∞}g[n]φ(2t−n) (3)

where g(k)=(−1)^{k}h(1−k). The wavelet transform of a signal f(x) can be calculated as follows:

c_{m,n}=∫_{-∞}^{∞}f(x)ψ_{m,n}(x)dx (4)

f(x)=Σ_{m,n}c_{m,n}ψ_{m,n}(x) (5)

Using a shift, multiply and sum technique called convolution, wavelets may be combined with portions of an unknown signal to extract information from the unknown signal. The theory of wavelets presents a common framework for numerous techniques developed independently for various signal and image processing applications such as multi-resolution image processing, sub-band coding, and wavelet series expansions. The conventional approach for the analysis of non-stationary signals is the short-time Fourier transform or Gabor transform. The advantage of the wavelet transform in comparison to Fourier transform is that short windows at high frequencies and long windows at low frequencies may be used to provide better signal resolution than the Fourier transform. See, e.g., Qiao et al., An Experimental Comparison on Gabor Wavelet and Wavelet Frame Based Features for Image Retrieval. In: Khosla R, Howlett R J, Jain L C, editors. Knowledge-Based Intelligent Information and Engineering Systems: Springer Berlin Heidelberg; 2005, p. 353-8. A signal can be decomposed to an approximation signal and a detail signal based on functions, which are obtained from a single mother wavelet by scaling or shift.

Using the wavelet transform, the texture properties may be characterized at multiple scales. See, e.g., Unser M., IEEE Transactions on Image Processing, 1995, 4(11):1549-60. A texture may characterized by a set of channel variances estimated at the output of a corresponding filter bank. Ultrasound image textures may provide important features for accurately defining the object, for example, a prostate, especially for the regions where object boundaries are not clear.

Different types of wavelet transforms may be used, each type may be for different applications. The implementation of the discrete wavelet frame transform may be similar to that of the discrete wavelet transform, except that there is no down sampling operation. In some embodiments, biorthogonal wavelets 1.3, 1.5, and 4.4 may be employed to extract the texture features of the prostate. Designing biorthogonal wavelets can allow more degrees of freedom compared to orthogonal wavelets.

One additional degree of freedom may be the possibility to construct symmetric wavelet functions. A biorthogonal wavelet may not necessarily be orthogonal. As in the orthogonal case, ψ₁(t), ψ₂(t), and φ(2t) may be related by scaling functions which are the consequence of the inclusions of the resolution spaces from coarse to fine. In the biorthogonal case, there may be two scaling functions that may generate different multi-resolution analyses, and accordingly two different wavelet functions. So the numbers of coefficients in the scaling sequences may differ.

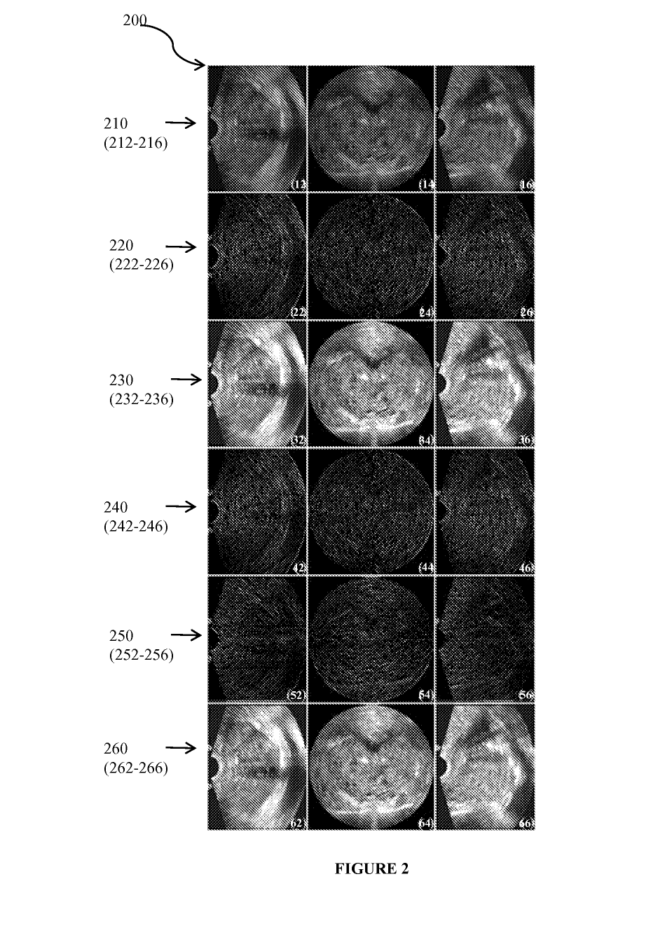

FIG. 2 shows an example 200 of feature extraction of images of a prostate using wavelet filters according to some embodiments. Row 210 shows original images 212, 214, and 216, in sagittal, coronal and transverse directions, respectively. Row 220 shows biorthogonal 1.3 for vertical details in images 222, 224, and 226 in sagittal, coronal and transverse directions, respectively. Row 230 shows biorthogonal 1.3 first approximation in images 232, 234, and 236 in sagittal, coronal and transverse directions, respectively. Row 240 shows biorthogonal 1.5 vertical details in images 242, 244, and 246 in sagittal, coronal and transverse directions, respectively. Row 250 shows biorthogonal 1.5 horizontal details in images 252, 254, and 256 in sagittal, coronal and transverse directions, respectively. Row 260 shows biorthogonal 4.4 first approximation in images 262, 264, and 266 in sagittal, coronal and transverse directions, respectively.

### Wavelet Support Vector Machine (W-SVM)

In some embodiments, the processing may further include classifying or identifying the texture features. As shown in FIG. 1, the processing may include steps 122, 125, and 128 of classifying the texture features for each of the planes, sagittal, coronal, and transverse planes, respectively. The classifying may include labeling or classifying voxels in a region as either object or non-object voxels.

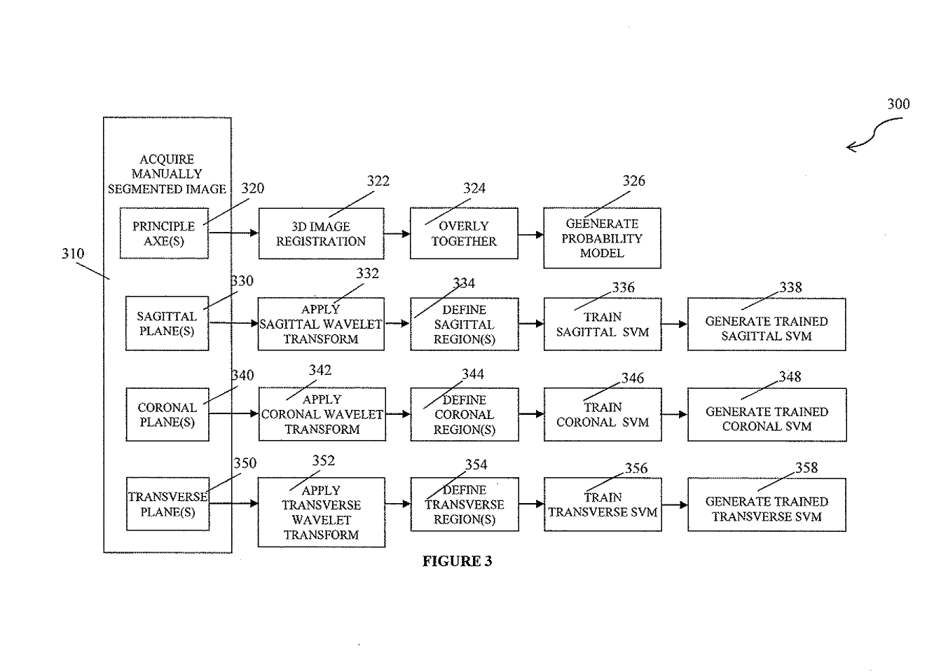

In some embodiments, support vector machines (SVM) may be employed or applied to identify the wavelet features of the object tissue. The SVM may be trained based on manually segmented images of the object. Although these features may greatly vary among different patients, the SVMs may nonlinearly classify texture features by extracting different wavelet features. The wavelet features may be determined and may be based on the training of the SVM for each plane, for example, as discussed with respect to FIG. 3.

Support vector machines (SVMs) are generally supervised classifiers that use a small number of exemplars selected from the tutorial dataset, with the intention to enhance the generalization ability. SVM has a pair of margin zones on both sides of the discriminate function. SVM is a popular classifier based on statistical learning theory as proposed by Vapnik. See, e.g., Vapnik V N, The Nature of Statistical Learning Theory, Berlin: Springer-Verlag, 1995. The SVM framework is more appropriate for empirical mixture modeling, as non-separable distributions of pure classes can be handled appropriately, as well as nonlinear mixture modeling. See, e.g., Brown et al., IEEE Transactions on Geoscience and Remote Sensing, 2000, 38(5):2346-60. The training phase of SVMs looks for a linear optimal separating hyperplane as a maximum margin classifier with respect to the training data.

In some embodiments, kernel-based SVM methods may be employed to classify the wavelet or texture features. Kernel-based SVM methods may be employed because the training data are not linearly separable. Kernel-based SVM methods map data from an original input feature space to a kernel feature space of higher dimensionality, and then solve a linear problem in that space. See, e.g., Akbari et al., International Journal of Functional Informatics and Personalised Medicine, 2009, 2(2):201-16.

In some embodiments, there may be a series of W-SVMS employed or applied to the extracted textures. The series may be assigned to different parts of the object to segment the object tissue because an object generally has different textures in different regions.

For example, with respect the prostate, because the prostate has different textures in different regions, a series of W-SVMs are assigned to different parts of the prostate in order to locally segment the prostate tissue. Therefore, each W-SVM segments a sub-region of the prostate with an intention to achieve robust classification of prostate texture features by kernel-based SVM.

In some embodiments, for the SVM model, the error function may be given by:

$$\frac{1}{2} {w}^{T} w - C ( v ɛ + \frac{1}{N} {\sum }_{i = 1}^{N} ( {ξ}_{i} + {ξ}_{i}^{*} ) ) \qquad ( 6 )$$

which may be minimized subject to:

(w^{T}φ(xᵢ)+b)−yᵢ≦ε+ξᵢ (7)

yᵢ−(w^{T}φ(xᵢ)+bᵢ)≦ε+ξᵢ* (8)

ξᵢ,ξᵢ*≧0,i=1, . . . ,N,ε≧0 (9)

where C is the capacity constant, w is the vector of coefficients, b a constant, and ξᵢ are parameters for handling input data. The index i labels the N training cases. y ε±1 is the class label, and xᵢ is the independent variable. The kernel φ is used to transform data from the input to the feature space. There may be a number of kernels that can be used in SVM models.

In some embodiments, radial basis function (RBF) may be employed as follows:

φ=exp(−γ|xᵢ−xⱼ|²) (10)

The RBF is generally one of the most popular kernel types employed in SVM. This kernel may result in localized and finite responses across the full range of the real x-axis.

In some embodiments, trained W-SVMs may be employed to tentatively label or classify voxels around the surface as either object or non-object voxels. In some embodiments, the KSVMs have may be trained by a set of 3D TRUS image samples in coronal, sagittal, and transverse planes and at each sub-region to label the voxels based on the captured Wavelet texture features. The W-SVMs may be localized, trained, and employed at different regions and in the coronal, sagittal, transverse planes. By using these tentatively labeled maps, the surface of the object may be delineated based on the boundary between the tentatively labeled object and non-object voxels in the three planes.

In some embodiments, each voxel may be labeled or classified in three planes simultaneously. In some embodiments, each voxel may be labeled or classified by three sub-regional KSVMs in three planes separately. Each voxel in each plane may be labeled by a real value between 0 and 1 that represents the likelihood of a voxel belonging to the object tissue.

In some embodiments, the processing may include a probability shape model (also referred to as probability shape model reference). In these embodiments, each voxel may have a label of the probability shape model and three labels for KSVM in three planes. After defining special weight for each label at each region by applying weight functions, each voxel tentatively may be labeled as prostate or non-prostate voxel.

In some embodiments, weight functions may be applied to each classified voxel in the three planes, separately. As shown in FIG. 1, the processing may include steps 123, 126, and 129 of applying weight functions to voxels in each region according to sagittal, coronal, and transverse planes, respectively. The weight functions may be a predetermined set of parameters specific to the object. The weight functions may be based on experience and/or knowledge of the object.

For each voxel in each region, three weight functions may be assigned corresponding to the segmentation in the three planes.

W_{S}L_{S}+W_{C}L_{C}+WₜLₜ (11)

where W_{S}, W_{C}, and Wₜ are weight functions in the sagittal, coronal, and transverse planes, respectively. L_{S}, L_{C}, and Lₜ are SVM labels in the sagittal, coronal, and transverse planes, respectively. These weight functions may be obtained from the optimization processing that finds the best result from a number of manually segmented images of an object tissue. It may be any number. In some embodiments, the number may be 10.

In some embodiments, a number of W-SVMs on different regions of a surface model reference may be placed and trained to adaptively label the tissue based on its texture and location. In some embodiments, each W-SVM may include 5 wavelet filter banks, voxel coordinates, and a kernel-based SVM.

FIG. 3 shows an example of a method to generate trained SVMs in each region. As shown in FIG. 3, a number of manually segmented images of an object may be received. The number of manually segmented images may be any number. As shown in FIG. 3, a plurality of manually segmented images from different objects, e.g., prostates, may be acquired in step 310. There may be any number of manually segmented images. There may be at least ten, twenty, thirty, forty, fifty, sixty, seventy, eighty, ninety, one hundred, or more than one hundred images received. The images may include image data for each principal plane of the object.

In some embodiments, the SVM may be trained from these images. The SVM may be trained in each principal direction. For example, as shown in FIG. 3, the images received may be separated into the principal axes, sagittal plane 330, coronal plane 340, and transverse plane 350. For each of these planes, the respective SVM may be applied (steps 332, 342, and 352, respectively). The specific plane regions may be defined or determined (steps 334, 344, and 354). The SVM for each plane may be trained based on these images (steps 336, 346, and 356). The SVM may be trained based on predetermined or determined parameters or features. After which, a trained SVM may be generated for each plane. For example, trained sagittal SVM, coronal SVM, and transverse SVM may be generated (steps 338, 348, and 358, respectively).

In some embodiments, the method may include a step of generating a segmented image(s). The generated segmented image may be an initial segmented image. The initial segmented image may correspond to the image of the object segmented based on wavelet support vector machine (W-SVM). As shown in FIG. 1, the method 100 may include a step 140 of generating segmented image(s).

The (initial) segmented image may be modified based on the probability shape (reference) model and an intensity profile.

### Probability Shape Reference Model

The method may further include a step of registering 150 the (initial) segmented image to a probability shape reference model (also referred as “probability model” or “probability shape model”). Based on the registration, the segmented image(s) may be modified. The method may include a step 152 of acquiring a probability shape reference model. In some embodiments, the probability shape reference model may be stored on a storage memory.

The probability reference model may be created or generated using a number of manually segmented images of an object. There may be any number of images. There may be a plurality of images. For example, there may be at least ten images, twenty images, thirty images, forty images, fifty images, sixty images, seventy images, eighty images, ninety images, one hundred images, or more than one hundred images. The images may be binary 3D images. In some embodiments, the probability shape reference model may be scaled to the size of the box(es) defined in the manual intervention step. FIG. 3 illustrates an example of a method to generate a probability shape model.

The segmented images may be registered through the principle axis transformation. The registered models may be overlaid together and create a probability model of the object, within which each pixel is labeled with a value between 1 and 10.

In some embodiments, the principal axis transformation may be inspired from the classical theory of rigid bodies. See, e.g., Faber T L and Stokely E M, IEEE Transactions on Pattern Analysis and Machine Intelligence, 1988, 10(5):626-33. A rigid-body can be uniquely localized by defining the coordination of its center of mass and its orientation with respect to its center of the mass. For any rigid body, the center of mass and principal axes may be determined based on the geometry of the object. For symmetric geometries, axes of symmetry are same as the principal axes and in general, form an orthogonal coordinate system, with their origin at the center of mass. See, e.g., Alpert et al., J NuclMed., 1990, 31(10):1717-22. The inertia matrix in the principal axis coordinate system may be diagonal.

Assuming two orientations and locations for a volume with no assumptions about the orientation or location of the reference volumes. If the reference volumes represent the same object, the centers of mass C₁ and C₂ will represent the same physical point in the object, independent of orientation or scale. The inertia matrices, Iᵢ, for the two reference volumes may be expressed as a similarity transformation:

Iᵢ=SᵢISᵢ^{T} (12)

where I may be the inertia matrix in the principal axis coordinate system, Sᵢ may be the rotation matrix that is the matrix of eigencolumns determined from Iᵢ, and the eigencolumns may be orthonormal vectors directed along the principal axes. This equation may geometrically represent a rotation of I relative to the original image coordinate axes. I₁ and I₂ may be related by following equation:

I₂=S₂S₁^{T}I₁S₁S₂^{T} (13)

Registration of first image to a second image may be obtained by a translation to the center of mass coordinate system followed by the rotation S₁S₂^{T}. Then the size of 3D object images may be scaled in three axes based on principle axes lengths. After registration, the object models may overlay together, and the shape probability model may be created based on the number of overlaying objects in each voxel.

FIG. 3 shows an example of generating a probability shape model for an object. The probability shape model may be generated using the same images used to train the SVMs. In other embodiments, the probability shape model may be generated using a plurality of manually segmented images of an object. In some embodiments, the image data may include image data for the principle axes, or the image data may be processed to acquire the principle axes (step 320). The images may then be registered (step 322). After which, all of the images may be overlaid together (step 324). From the overlaid images, a probability shape model of the object may be generated (step 326).

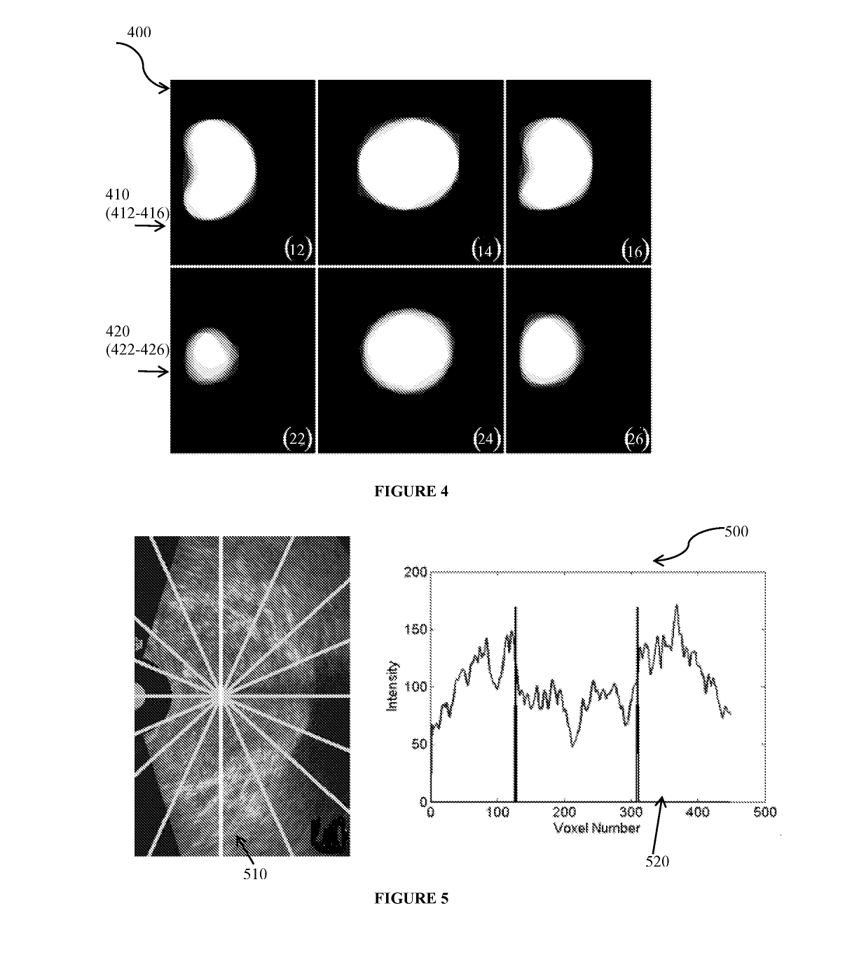

FIG. 4 shows an example of a reference probability model for the prostate in three planes and at different sections. 3D probability shape model of the prostate in the sagittal (images 412 and 422), coronal (images 414 and 424), and transverse (images 416 and 426) directions (or planes). The intensity represents the probability of the voxel that belongs to prostate tissue with a probability range from 100% (white) to zero (dark). The top 410 and bottom rows 420 represent different slice positions.

### Intensity Profile Model

The method may further include a step of modifying a boundary between object and non-object data in each plane based on an intensity profile. The segmented image (based on SVM) may be adjusted or regenerated on the modified boundary. In some embodiments, this step may depend on the registration of the classified image to the probability model. The step of modifying may be repeated until at least one set of parameters is met.

As shown in FIG. 1, the method 100 may include a step 130 of determining at least one intensity profile of the image received. The intensity profiles may be stored on a storage memory. There may be a plurality of intensity profiles received. The determined intensity profile(s) may correspond to an average of the intensity profiles.

The method 100 may further include a step of determining a boundary 132 between the object and non-object data based on the intensity profiles. The determined boundary for the image may be compared to the boundary of the generated segmented image (based on SVM) and adjusted based on that comparison.

For example, for ten images, Lₚ (p=1, . . . , 10) may be the intensity profile along the lines passing through the center of mass of the object (e.g., prostate) and including both sides of the object boundary (e.g., prostate boundary).

$$L = \frac{1}{4 {l}^{2}} {\sum }_{i = - l}^{i = l} {\sum }_{j = - l}^{j = l} I {\vert}_{B - k}^{B + k} \qquad ( 14 )$$

where I is a voxel intensity, i and j are two orthogonal directions regarding to the profile axis, 2 l is the profile width, 2 k is the profile length, and B is the location of the boundary of the object (e.g., prostate) in the profile. The profiles may then be evaluated in all angles and with different widths. Considering just one single line of voxels, very noisy results can be obtained.

In some embodiments, the width of voxels of the intensity profiles may be adjusted based on the intensity profile shape of the objects represented in the image. For example, when the width increases, the intensity profile may show more consistent shape in different patients. Therefore, the profile width may be increased to find a consistent intensity profile shape among all prostates.

FIGS. 5 through 7 show examples of intensity profiles. FIG. 5 shows an example 500 of an ultrasound image of a prostate. Ultrasound image 510 is an example of the prostate that shows the center of mass and the cubes passing through the center with different angles. Intensity profile 520 corresponds to the white cube in the image 510. The black vertical lines show the location of the prostate boundaries. The white cube has a width of 9 voxels.

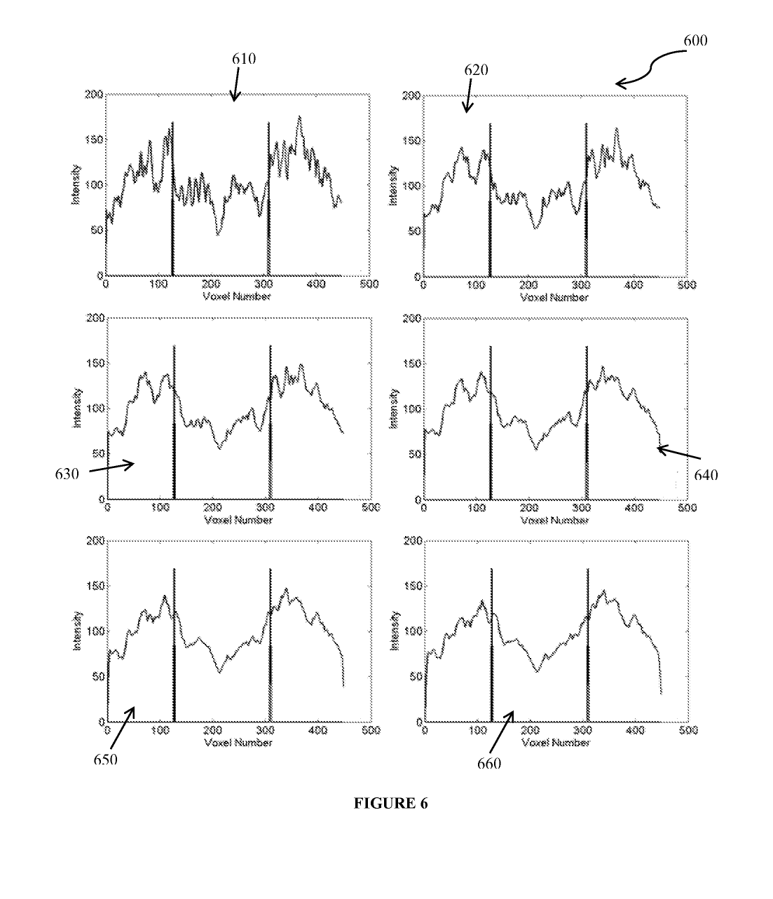

FIG. 6 shows a sample 600 of intensity profiles of the prostate in three orthogonal directions with different cube widths. Intensity profile 610 has a width of 3 voxels; intensity profile 620 has a cube width of 19 voxels; intensity profile 630 has a cube width of 39 voxels; intensity profile 640 has a cube width of 59 voxels; intensity profile 650 has a cube width of 79 voxels; and intensity profile 660 has a cube width of 99 voxels.

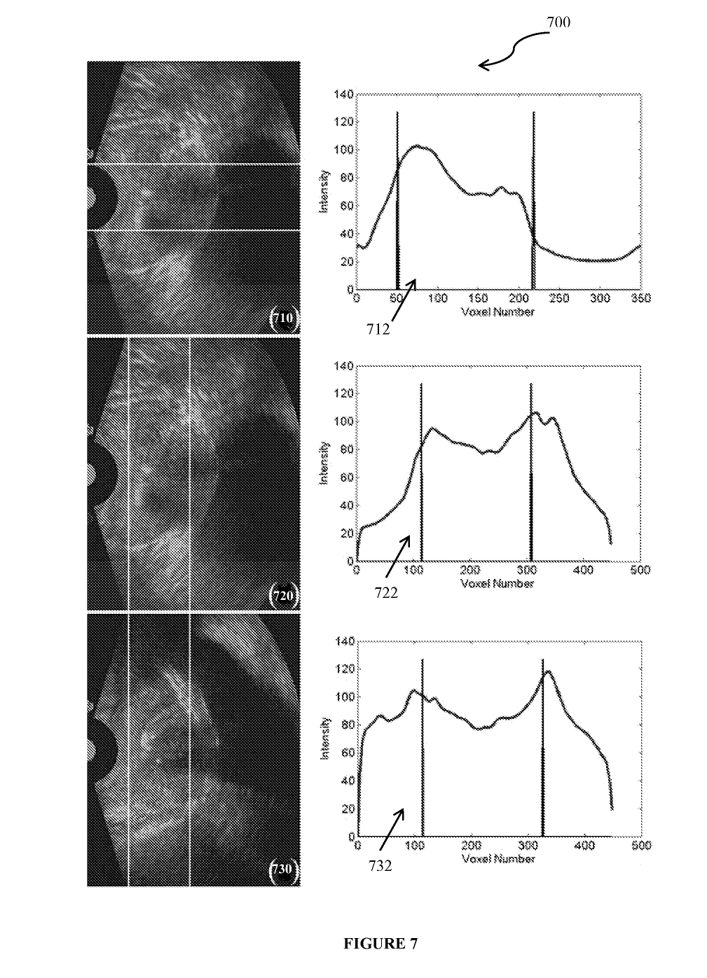

FIG. 7 shows a sample 700 of intensity profiles in three orthogonal directions. Images 710, 720, and 730 are prostate ultrasound images in three different orthogonal directions. Intensity profiles 712, 722, and 732 of the cubes passing through the prostate correspond to images 710, 720, and 730, respectively. The width of the cubes is 101 pixels and the profiles pass through the center of mass of the prostate. The profiles are parallel with sagittal, coronal, and transverse planes. The white lines on the images show cube boundaries. The black vertical lines on the profiles show the location of the prostate boundaries.

In some embodiments, the boundary of the generated segmented image may be modified based on the comparison of the boundaries of the intensity profile to the (registered) segmented image (step 160). In some embodiments, the boundary determined from the intensity profiles may be compared to the corresponding boundary determined of the registered, generated (SVM) segmented image. The boundary may be determined by comparing the segmented image with the intensity profile to determine similarities. The method may then determine to modify the boundary based on predetermined parameters (yes at step 162). The parameters may include but is not limited to the boundary being consistent (i.e., no change or insubstantial change in the boundary) after a predetermined number of updates, predetermined number of updates of the segmented image, and similarities between the boundaries. For example, the method may stop modifying if a predetermined number of updates has been reached, no boundary changes have occurred after a predetermined number of updates, or certain similarities between the boundaries are determined. In some embodiments, step 162 may be omitted. If the method determines that the boundary should not be modified (no at step 162), the segmented or updated image (from step 140) may be outputted (step 170). If the method determines that the boundary should be modified (yes at step 162), the boundary may be modified and the segmented image may be updated based on the modified boundary. These steps may be repeated until the method determines that the boundary should not be modified.

### Outputting

In some embodiments, the method may include a step 170 of outputting the segmented image(s). The segmented image(s) may be outputted based on the modification determination (yes at step 162). The outputted image may be a segmented image based on W-SVM and the probability model.

In some embodiments, the outputted segmented image(s) may include at least one of segmented sagittal image, segmented coronal image, and segmented transverse image. In some embodiments, each image may be outputted simultaneously. Each image may be outputted when the processing is completed for that image. In some embodiments, each image may be outputted when the processing for all images is completed. In some embodiments, processing may be completed when the segmented image converges with the probability model.

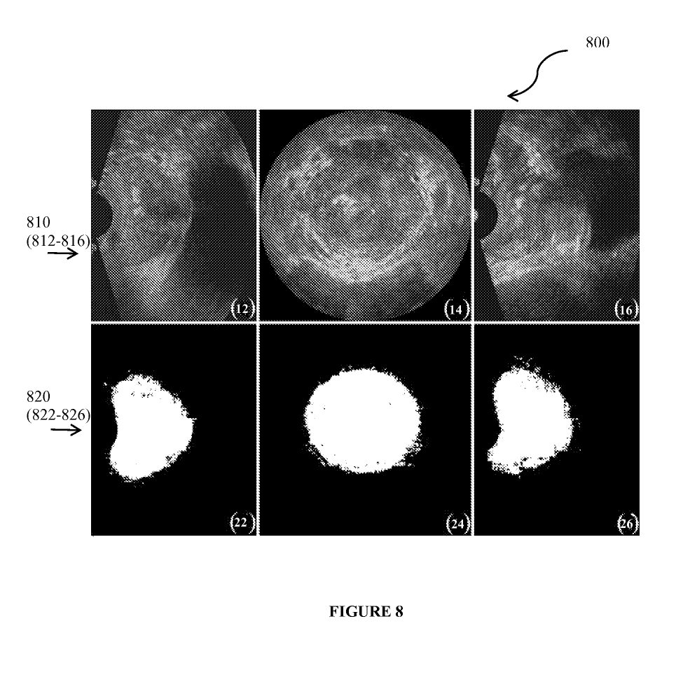

FIG. 8 shows an example of a segmented prostate according to the embodiments of the segmentation method. Row 810 shows original images 812, 814, and 816, in the sagittal, coronal, and transverse planes, respectively. Row 820 shows the segmented images (the segmented prostate in the corresponding images). Images 822, 824, and 826 show the segmented prostate in the sagittal, coronal, and transverse planes, respectively.

In some embodiments, the outputting may include but is not limited to displaying the segmented image(s), printing the segmented image(s), and storing the segmented image(s) remotely or locally. In other embodiments, the segmented image(s) with may be transmitted for further processing. In some embodiments, the segmented image(s) may be transmitted to an ultrasound system to be displayed. In some embodiments, a location of a biopsy probe may be displayed on the segmented image.

### Evaluation Criteria

In some embodiments, the method may further include assessing the performance of the segmentation after one or more images are outputted. The assessment may be a quantitative performance assessment.

Ins some embodiments, quantitative performance assessment of the method may be performed by comparing the results (e.g., outputted images) with the corresponding gold standard from manual segmentation. The Dice similarity may be employed as a performance assessment metric for the prostate segmentation algorithm. The Dice similarity may be computed as follows:

$$Dice ( S , G ) = \frac{2 \vert S ⋂ G \vert}{\vert S \vert + \vert G \vert} 100 \% , \qquad ( 15 )$$

where S may represent the voxels of the prostate segmented by the algorithm, and G may represent the voxels of the corresponding gold standard from manual segmentation.

The volume error may be used as another performance assessment metric to evaluate the prostate segmentation algorithm. Volume error, VE(S, G), may represent the signed volume error of a segmented prostate volume, S, compared to the gold standard, G, as a percentage of the gold standard prostate volume. Volume error may be described as follows

VE(S,G)=(S−G)/G×100%, (16)

Sensitivity, Sen(S, G), may represent the proportion of the segmented prostate volume, S, that may be correctly overlapped with the gold standard volume, G.

Sen(S,G)=TP/G×100%, (17)

where TP is the true positive volume and represents the overlapped volume of the segmented prostate and the gold standard. See, e.g., Cool et al., MedImage Anal., 2006; 10(6):875-87.

The evaluation criteria may also include false positive rate (FPR) and false negative rate (FNR). When a voxel was not detected as an object (e.g., prostate) voxel, the detection may be considered a false negative if the voxel was a voxel of prostate on the gold standard that was established by manual segmentation. The FNR may be defined as the number of false negative voxels divided by the total number of the prostate voxels on the gold standard. When a voxel was detected as object (e.g., prostate) voxel, the detection was a false positive if the voxel was not a prostate voxel on the gold standard. The FPR may be defined as the number of false positive voxels divided by the total number of non-prostate voxels on the gold standard. The gold standard may be a binary image consisting of voxels that are labeled as prostate, and other voxels that are assumed as non-prostate voxels.

Error ratio map represents the proportion of the volume that is not correctly overlapped with the gold standard volume. As is shown in Eq. (18), false positive volume and false negative volume may the key parts of the calculation method.

$$ER ( S , G ) = \frac{FP + FN}{G + S} 100 \% , \qquad ( 18 )$$

where FP and FN are false positive and false negative respectively.

### System Implementation

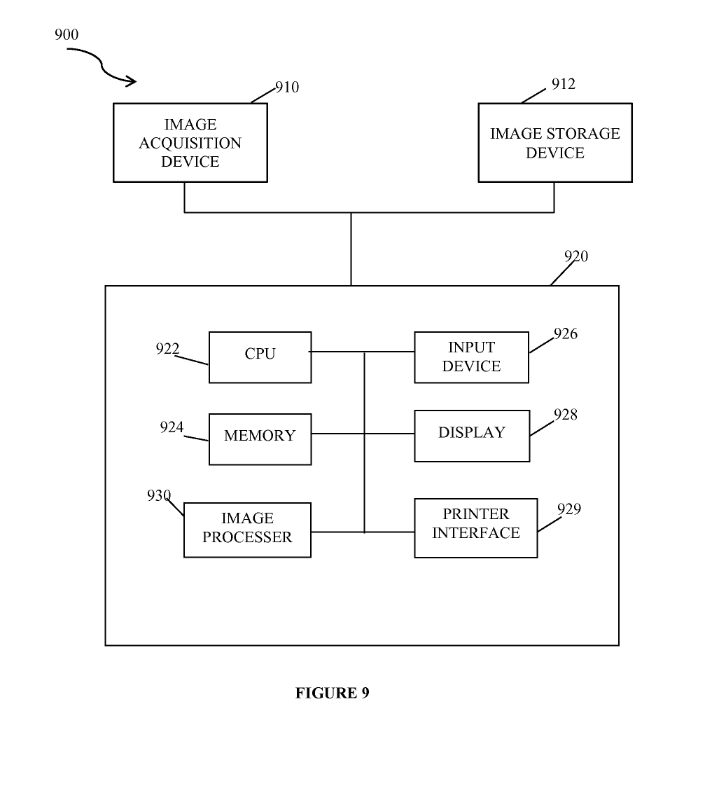

FIG. 9 shows an example of a system 900 configured to process and segment images of an organ, for example, a prostate. The system for carrying out the embodiments of the methods disclosed herein is not limited to the system shown in FIG. 9. Other systems may be used. The models of the system may be communicably connected to each other as well as other modules on a hospital network by a wired or wireless network.

In some embodiments, the system 900 may include at least image acquisition systems (modalities) to acquire image data of a patient. The image acquisition devices may include at one image acquisition system 910.

The image acquisitions system may be an ultrasound system. In some embodiments, the ultrasound system may be a part of a biopsy system, and may include an ultrasound probe. In some embodiments, the ultrasound system may be configured to acquire transrectal ultrasound (TRUS) images. In other embodiments, the ultrasound system may be configured to acquire another anatomical regions.

The image acquisition device may be communicably connected to a local or remote medical image storage device 912. The image acquisition device may be communicably connected to a wired or wireless network.

The system 900 may further include a computer system 920 to carry out the classifying of the tissue and generating a classified image. The computer system 920 may further be used to control the operation of the system or a computer separate system may be included.

The computer system 920 may also be communicably connected to another computer system as well as a wired or wireless network. The computer system 920 may receive or obtain the image data from the image acquisition device 910 or from another module provided on the network, for example, a medical image storage device 912.

The computer system 920 may include a number of modules that communicate with each other through electrical and/or data connections (not shown). Data connections may be direct wired links or may be fiber optic connections or wireless communications links or the like. The computer system 920 may also be connected to permanent or back-up memory storage, a network, or may communicate with a separate system control through a link (not shown). The modules may include a CPU 922, a memory 924, an image processor 930, an input device 926, a display 928, and a printer interface 929.

The CPU 922 may any known central processing unit, a processor, or a microprocessor. The CPU 922 may be coupled directly or indirectly to memory elements. The memory 924 may include random access memory (RAM), read only memory (ROM), disk drive, tape drive, etc., or a combinations thereof. The memory may also include a frame buffer for storing image data arrays. In some embodiments, the memory may store generated or created reference intensity profiles and reference probability shape models for each object. In some embodiments, the memory may store generated or created reference intensity profiles and reference probability shape models for a plurality of objects. In other embodiments, the generated or created reference intensity profiles and reference probability shape models may be stored on a memory on the network.

The present disclosure may be implemented as a routine that is stored in memory 924 and executed by the CPU 922. As such, the computer system 920 may be a general purpose computer system that becomes a specific purpose computer system when executing the routine of the disclosure.

The computer system 920 may also include an operating system and micro instruction code. The various processes and functions described herein may either be part of the micro instruction code or part of the application program or routine (or combination thereof) that is executed via the operating system. In addition, various other peripheral devices may be connected to the computer platform such as an additional data storage device, a printing device, and I/O devices.

The input device 926 may include a mouse, joystick, keyboard, track ball, touch activated screen, light wand, voice control, or any similar or equivalent input device, and may be used for interactive geometry prescription. The input device 926 may control the production, display of images on the display 928, and printing of the images by the printer interface 929. The display 928 may be any known display screen and the printer interface 929 may any known printer, either locally or network connected.

The image processor 930 may be any known central processing unit, a processor, or a microprocessor. In some embodiments, the image processor 930 may process and segment the images to generate segment images. In some embodiments, the image processor may be configured to generate or create reference intensity profiles and reference probability shape models for an object. In some embodiments, the image processor may evaluate the performance of the segmentation of images. In other embodiments, the image processor 930 may be replaced by image processing functionality on the CPU 922.

In some embodiments, the segmented images may be stored in the memory 924. In other embodiments, another computer system may assume the image segmentation or other functions of the image processor 930. In response to commands received from the input device 926, the image data stored in the memory 924 may be archived in long term storage or may be further processed by the image processor 930 and presented on the display 929. In some embodiments, the segmented images may be transmitted to the image acquisition system 910 to be displayed.

It is to be understood that the embodiments of the disclosure be implemented in various forms of hardware, software, firmware, special purpose processes, or a combination thereof. In one embodiment, the disclosure may be implemented in software as an application program tangible embodied on a computer readable program storage device. The application program may be uploaded to, and executed by, a machine comprising any suitable architecture. The system and methods of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

It is to be further understood that, because some of the constituent system components and method steps depicted in the accompanying figures can be implemented in software, the actual connections between the systems components (or the process steps) may differ depending upon the manner in which the disclosure is programmed. Given the teachings of the disclosure provided herein, one of ordinary skill in the related art will be able to contemplate these and similar implementations or configurations of the disclosure.

All references cited herein are hereby incorporated by reference in their entirety.

While various embodiments of the disclosure have been described, the description is intended to be exemplary rather than limiting and it will be appeared to those of ordinary skill in the art that may more embodiments and implementations are possible that are within the scope of the disclosure.

What is claimed:

1. A method for processing at least one image of a target object, the image including image data in at least three different planes, comprising:
processing the image data in each plane to segment the target object represented by the image, the processing including classifying the image data based on a reference probability shape model and an intensity profile; and
generating at least one segmented image.

2. The method according to claim 1, wherein the processing includes separately classifying the image data in each plane.

3. The method according to claim 1, wherein the target object is a prostate, breast, lung, lymph node, kidney, cervix, and liver.

4. The method according to claim 1, wherein the processing the image data includes processing regions of the image.

5. The method according to claim 1, wherein the processing includes:
extracting texture features in each plane; and
classifying the texture features in each plane as object data or non-object data.

6. The method according to claim 5, wherein the extracting includes applying a wavelet transform to image data in each plane.

7. The method according to claim 5, wherein the classifying includes applying a trained support vector machine.

8. The method according to claim 7, wherein the support vector machine is a kernel-based support vector machine.

9. The method according to claim 1, further comprising:
registering the generated segmented image to the probability model.

10. The method according to claim 9, wherein the intensity profile includes at least one boundary based on the image received, further comprising:
comparing at least one boundary between the object data and the non-object data of the generated image to a corresponding boundary of the intensity profile; and
modifying at least one boundary between the object data and the non-object data of the generated segmented image based on the comparing; and
generating an updated segmented image based on the modified boundary.

11. The method according to claim 10, further comprising:
outputting the generated segmented image based on the comparing and modifying.

12. The method according to claim 1, further comprising:
outputting the generated segmented image.

13. The method according to claim 1, wherein the image is an ultrasound image.

14. A computer-readable storage medium storing instructions for processing at least one image of a target object, the image including image data in at least three different planes, the instructions comprising:
processing the image data in each plane to segment the target object represented by the image, the processing including classifying the image data based on a reference probability shape model and an intensity profile; and
generating at least one segmented image.

15. The medium according to claim 14, wherein the processing includes:
extracting texture features in each plane; and
classifying the texture features in each plane as object data or non-object data.

16. The medium according to claim 15, wherein:
the extracting includes applying a wavelet transform to image data in each plane; and
the classifying includes applying a trained support vector machine.

17. The medium according to claim 15, further comprising instructions for:
registering the generated segmented image to the probability model;
comparing at least one boundary between the object data and the non-object data of the generated image to a corresponding boundary of the intensity profile;
modifying at least one boundary between the object data and the non-object data of the segmented based on the comparing; and
generating an updated segmented image based on the modified boundary.

18. A system configured to process at least one image of a target object, the image including image data in at least three different planes, comprising:
an image processor, the image processor being configured to:
process the image data in each plane to segment the target object represented by the image, the process including classify the image data based on a reference probability shape model and an intensity profile; and
generate at least one segmented image

19. The system according to claim 18, wherein the image processor is configured to process the image data by extracting texture features in each plane and classifying the texture features in each plane as object data or non-object data.

20. The system according to claim 19, wherein the processor is configured to apply a wavelet transform to image data in each plane to extract the texture features; and is configured to apply a trained support vector machine to classify the texture features.
